(19) United States
(12) Patent Application Publication
(10) Pub. No.: US 2010/0270504 A1
(43) Pub. Date: Oct. 28, 2010

(54) PHOTOLUMINESCENT METAL NANOCLUSTERS

(75) Inventor: Lianhua Qu, Pittsburgh, PA (US)

Correspondence Address: PEPPER HAMILTON LLP, ONE MELLON CENTER, 50TH FLOOR, 500 GRANT STREET, PITTSBURGH, PA, 15219, US

(73) Assignee: CRYSTALPLEX CORPORATION, Pittsburgh, PA (US)

(21) Appl. No.: 12/769,479

(22) Filed: Apr. 28, 2010

Related U.S. Application Data
(60) Provisional application No. 61/214,785, filed on Apr. 28, 2009.

(51) Int. Cl. C09K 11/02

(52) U.S. Cl. 252/301.36

(57) ABSTRACT

Nanoclusters comprising a metal core and outer ligand layer and methods of making and use them are disclosed. The nanoclusters have properties which are tunable by virtue of adjusting various aspects of the reaction.

This application claims benefit of priority to U.S. Provisional Patent Application No. 61/214,785 filed on Apr. 28, 2009, the entire contents of which are hereby incorporated by reference.

### BACKGROUND

Over the past few decades, much progress has been made in the synthesis and characterization of a wide variety of semiconductor quantum dots. Recent advances have led to large-scale preparation of relatively monodisperse quantum dots (Murray et al., J Am. Chem. Soc, 115, 8706-15 (1993); Qu et al. JACS 124:2049 (2002), Nanoletters 1:333 (2001), and Nanoletters 4: 465 (2004); Bowen Katari et al., J Phys. Chem., 98, 4109-17 (1994); and Hines et al., J Phys. Chem., 100, 468-71 (1996)). Other advances have led to the characterization of quantum dot lattice structures (Henglein, Chem. Rev., 89, 1861-73 (1989); and Weller et al., Chem. Int. Ed. Engl. 32, 41-53 (1993)) and also to the fabrication of quantum-dot arrays (Murray et al., Science, 270, 1335-38 (1995); Andres et al., Science, 273, 1690-93 (1996); Heath et al., J Phys. Chem., 100, 3144-49 (1996); Collier et al., Science, 277, 1978-81 (1997); Mirkin et al., Nature, 382, 607-09 (1996); and Alivisatos et al., Nature, 382, 609-11 (1996)) and light-emitting diodes (Colvin et al., Nature, 370, 354-57 (1994); and Dabbousi et al., Appl. Phys. Let., 66, 1316-18 (1995)). In particular, IIB-VIB semiconductors have been the focus of much attention, leading to the development of CdSe quantum dots that have a high degree of monodispersivity and crystalline order.

Further advances in semiconductor quantum dot technology have resulted in the enhancement of the fluorescence efficiency and stability of the quantum dots. The luminescent properties of quantum dots arise from geometric quantum confinement, which occurs when metal and semiconductor core particles are smaller than their exciton Bohr radii—about 1 to 5 nra (Alivisatos, Science, 271, 933 (1996); Alivisatos, J Phys. Chem., 100, 13226-39 (1996); Brus, Appl Phys., A 53, 465-74 (1991); Wilson et al., Science, 262, 1242-46 (1993); Henglein (1989), supra; and Weller (1993), supra). Recent work has shown that improved luminescence efficiency and stability can be achieved by capping a size-tunable lower band gap core particle with a shell material that has a higher band gap.

Because of their established synthetic methods and unique chemical, physical, optical, electronic and electrical properties, semiconductor quantum dots have attracted considerable attention not only in research but in commercial applications such as fluorescent reagents for life science research and diagnostics, solid state lighting, displays, photovoltaics, high density memory, quantum dot lasers, optical communication and security inks (Bruchez et al., science 281, 2013 (1998); Chan et al., Science 281, 2016 (1998); Dubertret et al., Science 298, 1759 (2002)).

Quantum dots that contain heavy metals such as cadmium selenide (CdSe), cadmium sulfide (CdS), lead selenide (PbSe), lead sulfide (PbS) and their alloys are currently the most widely used materials. However, their use is restricted due to growing public safety concerns over the toxicity of heavy metals. This concern is especially strong in the European Union. As a result, the development of non-heavy metal nanoparticles with comparable properties has become important. Non-heavy metal nanoparticles such as III-V Si quantum dots have been synthesized, but their properties and performance with respect to stability, quantum efficiency and synthetic methods are inferior to CdSe quantum dots. The problems directly relate to the atomic properties of the semiconductor materials as they relate to the core-shell structure of quantum dots. These problems may be addressed by building simpler structures such as nanoparticles consisting of clusters of atoms of a single metal. These structures may be termed nanoclusters.

These nanoclusters have the potential to become highly polarized (compared to the bulk material) when they are a certain size. Their optical and electronic properties are markedly changed when the nanocluster cluster size is about 0.5 nanometers and below (the Fermi wavelength of an electron). Discrete energy levels are possible in the atom clusters that are not possible in the bulk metal. A nanocluster of about ten atoms can exhibit transitions from an atomic state to an energy band state. This is especially true when the excitation energy of the ten-atom nanocluster is at a level lower than the metallic plasmon absorption wavelength. A phase transition can occur from a state with a very small or non-existent band gap into a phase that has band gap properties typical of bulk semiconductor materials. This results in photoluminescent behavior similar to quantum dots.

With increasing cluster size and temperature, competition between different relaxation pathways such as vibration, fluorescence and fragmentation increases. Due to the characteristic time scale of relaxation, relaxation processes that do not produce radiation can predominate and quench fluorescence in metal nanoclusters. With the exception of small silver metal clusters, nanoclusters of metal atoms typically do not exhibit fluorescence. Many have Raman scattering properties and these properties have been shown to be useful in applications such as photothermal detection, single-molecule observation and observations on surfaces and colloids. The intensities of Raman emissions may be selectively enhanced and this selectivity is important in identifying particular molecular vibrations and for locating electronic transitions within the target molecule's absorption spectrum. This can be done even when the direct electronic spectra are vibrationally unresolved. However, metal nanoclusters would have enhanced utility if they were also truly fluorescent and photo luminescent.

Photoluminescent noble metal (silver) clusters with 2 to ten atoms have been reported and investigated at low temperatures in matrix isolated conditions. The low temperature fluorescence of silver nanoclusters during deposition in a noble gas matrix disappears when the temperature is raised. This so called “cage effect” prevents clusters from forming as stable individual nano particles. The nanoclusters have fluorescence only at low temperature and the fluorescence lasts only a few seconds under constant illumination. This instability is an issue for many applications. In addition, the synthetic methods reported previously produce nanoclusters that are variable in size in a single batch. This results in variability in the fluorescent emission. This restricts their utility in many applications. Accordingly, better fluorescent nanoclusters are desirable.

### SUMMARY

Some embodiments of the invention provide a nanocluster comprising a photoluminescent metal core wherein said metal is selected from the elements found in groups IB, IIB, IIA, IVA, VA, and VIA of the periodic table; and a layer of organic ligands disposed outside of said core.

In some embodiments, the metal is selected from the elements found in groups IB, IIB, or IIIA of the periodic table of elements. In some embodiments, the metal is selected from the elements found in group IIA of the period table of elements. In some embodiments, the metal is aluminum or gallium.

In some embodiments, the organic ligands are single chain fatty acids, which may be substituted or unsubstituted.

In some embodiments, the nanoclusters comprise from about 3 to about 300 atoms, sometimes from about 3 to about 100 atoms

In some embodiments, the band gap of the nanocluster is tunable from about 0.2 Ev to 4 Ev.

In some embodiments, the emission wavelength can be selectively tuned from about 400 nm to about 650 nm.

In some embodiments, the nanocluster comprises a photoluminescent metal core wherein said metal is selected from the elements found in groups IB, IIB, IIIA, IVA, VA, and VIA of the periodic table; a shell layer wherein said shell layer is selected from a metal, metal oxide, or semi-conductor material; and a layer of organic ligands disposed outside of said shell layer.

In some embodiments, the semiconductor material is ZnS.

Some embodiments of the invention provide a method of making a nanocluster comprising adding a solution of metal precursor to a solution of a ligand dissolved in the absence of oxygen and under at about 300° C. and maintaining a reaction temperature of about 270° C. until the reaction is complete; adding an aliquot of metal precursor solution to the reaction mixture and stirring; repeating the addition step until the desired properties are attained.

Some embodiments include further providing the step of forming a shell layer between said core and said ligand layer, comprising dripping a capping solution comprising a precursor solution of a metal, metal oxide, or a semiconductor material into a solution containing a nanocluster sample to a ligand solution to yield nanoclusters having a metal core, a shell comprising said metal, metal oxide or semi-conductor material, and an outer ligand layer.

### BRIEF DESCRIPTION OF THE DRAWINGS

FIG. 1 is a graph depicting the emission spectra of aluminum nanoclusters in accordance with some embodiments of the invention.

FIG. 2 is a graph depicting the photostability of aluminum nanoclusters in accordance with some embodiments of the invention.

FIG. 3 is a graph depicting the emission spectrum of aluminum nanocluster in accordance with some embodiments of the invention.

### DETAILED DESCRIPTION OF ILLUSTRATIVE EXAMPLES

The invention demonstrates that highly efficient fluorescence is achievable and controllable in small atomic metal clusters of metals, and in some embodiments, non-noble metals. This fluorescence is achievable and reproducible due primarily to precise control of the size of the nanocluster, a low variability in size distribution of the nanocluster population and the atomic element chosen. Synthesis procedures are described that enable the precise control of size and size distribution in scalable batches. Nanoclusters as described herein are useful in several applications.

The present invention describes fluorescent metal nanoclusters, with preferred embodiments utilizing aluminum (Al) and gallium (Ga) to produce fluorescence in the visible range. Further preferred embodiments describe fluorescent metal nanoclusters that are coated with organic ligand molecules. In some embodiments, the fluorescence is photoluminescence.

Nanoclusters in accordance with some embodiments of the invention comprise a metal core surrounded by an outer layer of ligands. Further embodiments provide a nanocluster having a metal core, a capping layer and an outer ligand layer. By carefully selecting the metal cores, and controlling the nanocluster size, the properties of the nanocluster can be controlled and predicted.

The nanoclusters have quantum efficiencies comparable to or better than core/shell semiconductor quantum dots, such as CdSe/ZnS. Aluminum nanoclusters prepared with method number 4 below, have quantum efficiencies usually higher than 50% in the emission range from blue to red. For comparison, regular CdSe/ZnS quantum dots have 20-30% quantum efficiency in the blue range and above 50 in the red range. In accordance with some embodiments of the invention, nanoclusters have quantum efficiencies greater than or equal to about 50%.

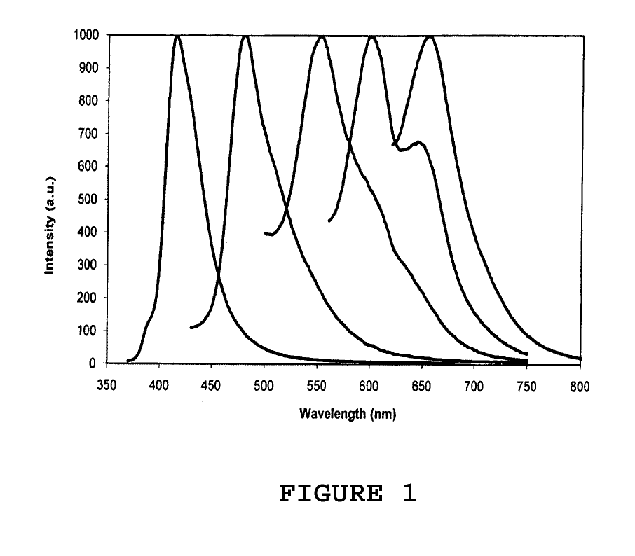

By preparing nanoclusters with sizes ranging from 0.2 run (approximately 3-5 atoms) to 2 run (approximately 100 atoms) the band gap can be tuned from 0.2-0.3 Ev to 3-4 Ev (corresponding to emission wavelengths in the visible range). FIG. 1 shows an example of aluminum clusters. By simply controlling the size of the nanocluster, through various conditions such as presence and amount of catalyst or the reaction time, the emission wavelength can be tuned from 400 nm to 650 nm. The methods described herein can be used to selectively create nanoclusters having a specific and desired emission wavelength in the visible spectra. By controlling the reaction, the chemist can control whether the resultant nanocluster emits, for example, blue or red.

It is important to note that in accordance with the methods of this invention, nanocluster batches may be formed to a discrete emission wavelength as described in method 1 below, or to a plurality of discrete emission wavelengths as in method 5 below. Preferred embodiments produce a discrete emission wavelength profile.

The smaller nanoclusters in accordance with the invention have utility in the life sciences as fluorescent labels that can penetrate deeper inside cells or tissues and the sensitivity of detection. For comparison, semiconductor quantum dots usually have a diameter of 3-10 nanometers. Additionally, the nanoclusters described here are relatively nontoxic compared to heavy metal based quantum dots and thus, make them better suited to medical applications than prior nanoclusters or quantum dots.

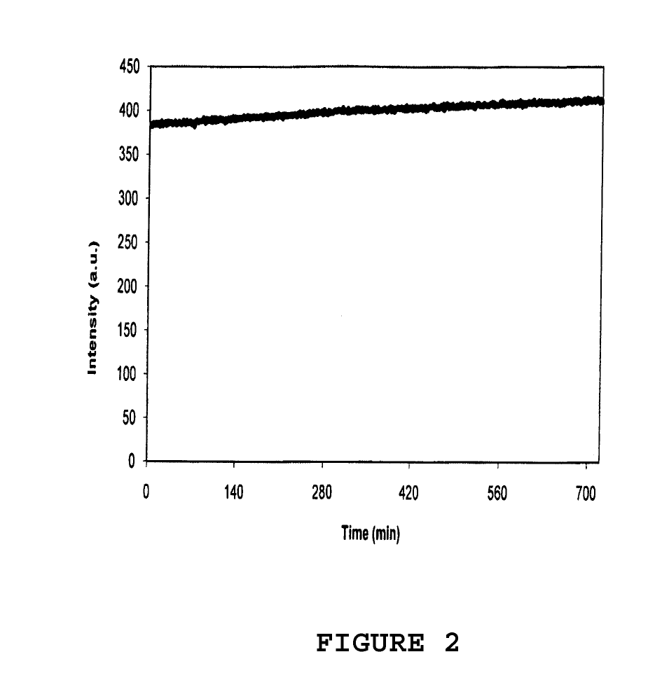

Stability testing was performed on a Shimadu RF5301 fluorescence spectrophotometer. An Al cluster sample made by example 4 below was placed on the spectrophotometer and the excitation slide kept open during the testing period, the emission intensity was measured at certain intervals, test results are provided in FIG. 2. After a 12 hour testing period, there no intensity decrease was observed, which indicates that the Al nanoclusters have at least comparable photo stability as the most stable quantum dots (Qu et al., passivated nanoparticles, US provisional, 2008). Moreover, clusters of a certain number of atoms form very stable configuration. For example, Al7 and Al13 are two clusters with band gaps of approximately 1.5 ev with emission wavelengths around 800 nm. They are more stable due to electronic (or geometric) shell closing. They have high binding energies per atom, large ionization potentials, and wide HOMO-LUMO gaps.

Because of the sensitive response of metal to light, the light/metal cluster coupling through dipole-dipole interaction can be tremendously increased. The strength of optical and electronic transitions is greatly enhanced due to the collective effect of electron oscillation. Metal nanoclusters at this size level are able to possess strong oscillator strengths and extremely high quantum efficiency, but at a much smaller size than other comparable nanomaterials.

The surface coating through ligand exchange or polymer encapsulation provides a flex surface which allows the nanoclusters to be compatible with different surrounding environments such as organic solvents, polymer matrix or inorganic materials.

Suitable metals for use in the present invention include those elements in the Periodic Table of Elements in groups IB, IIB, IIIA, IVA, and VA. As used herein, the elements of groups IVA, and VA, such as Si and As, which are not traditionally thought of as metals, are suitable for use as the metals herein. In some embodiments, the elements of group IB, IIB, and IIIA are used. In some embodiments, the elements of group IIIA are used. Preferred metals include Gallium and Aluminum. In each instance, alloys may also be used.

Suitable ligands include single chain fatty acids, which may be saturated or unsaturated. In some embodiments, single fatty acids having 8 to 18 carbons, which may be saturated or unsaturated are used. In some embodiments, up to two unsaturated carbon-carbon double bonds may be present. Exemplary ligands include, but are not limited to lauric acid and oleic acid. In some embodiments, trioctylphosphine oxide (TOPO) can be used as a ligand.

Suitable solvents are those suitable for use in the generation of quantum dots, such as those described in U.S. Patent Application No. 2007-0204790, including but not limited to heat transfer fluids, alkylated aromatics, aryl ethers, isomers of alkylated aromatics, alkyl benzenes, Dowtherm A (DTA), biphenyl (BP), phenyl ether (PE), Dowtherm G, Dowtherm RP, Dowtherm Q, Dowtherm J, Dowtherm HT, Dowtherm T, Dowtherm MX, terphenyls, Octadecene (ODE) and trioctylphosphine oxide (TOPO), trioctylphosphine [TOP] and combinations thereof. Octadecene (ODE) and trioctylphosphine oxide (TOPO) are particularly well-suited for use in some embodiments of the invention.

In some embodiments, the ligand may act as both ligand and solvent. In some embodiments, the solvent may act as both solvent and ligand. In some embodiments, a combination of a ligand and a solvent are used.

Some embodiments employ the optional use of a catalyst to drive and control the reaction. Suitable catalysts include metal salts, and particularly zinc salts derived from carboxylic acids. Exemplary salts include C₁-C₆ carboxylic acid salts, such as zinc acetate.

Some embodiments employ the use of semi-conductor material. The term “semi-conductor material” shall have the meaning normally given it by those of skill in the art. In particular, it is contemplated that semi-conductor materials include combinations of elements from groups IIB and VIA, and groups IIIA and VA on the periodic table of the elements. One suitable semi-conductor material is ZnS.

According to the methods of some embodiments of the invention, the metal is provided in a precursor. Suitable precursors include organometallic complexes, metal salts, and metal oxides. Exemplary organometallic complexes include fully substituted alkyl metallic complexes, such as trimethylaluminum or trimethylgallium. In this instance, “fully substituted” means that the metal's available valence electrons are fully substituted with a C₁-C₈ alkyl, in some embodiments, a C₁-C₃ alkyl. In the case of Al and Ga, there are three valence electrons and thus there would be three alkyl substitutions. In the case of Zn, there would be two alkyl substitutions corresponding to zinc's two valence electrons.

Synthetic methods described below lead to stable fluorescent nanoclusters with a narrow size distribution. The synthetic methods, described below allow for easy control of the reaction dynamics, and as a result, the final particle size, size distribution, and surface properties can be made in a controllable way.

### Synthesis Method

Preferred metal materials include Aluminum (Al) and Gallium (Ga) and their alloys. Preferred methods are batch reactions with initial conditions that include reactive metal precursors, a solvent with high boiling point (usually around 300° C.) and organic ligand molecules that coordinate and bind to the nanocluster surface. Alternatively, the nanoclusters may be grown in a coordinating solvent that serves as both solvent and ligand. Ligands are typically linear long chain organic molecules with a functional group on one or both ends that bind to the cluster surface. Ligands with certain chain lengths and functional groups enable control of the reaction dynamics and particle properties, such as size, size distribution, quantum efficiency and solubility. By controlling precursor type and concentration, ligand type and mixture ratio, the ligand to precursor ratio and reaction temperature and time, metal clusters with predictable and reproducible photoluminescent properties can be produced.

For example, aluminum nanoclusters were formed in accordance with the methods of the invention according to the chart below. FIG. 1 shows the results of each synthesis, corresponding to the desired wavelength, as shown below. By altering the amount of catalyst, the reaction efficiency is controlled. Thus, with substantially similar reaction conditions, the size of the cluster and thus the resultant wavelength, can be controlled. Similar results could be obtained, without altering the catalyst, for example by altering the reaction time.

### Method 1

Generally, nanoclusters in accordance with the invention can be prepared according to the following methods:

1. Preparing a desired amount of a ligand solution, wherein the ligand (e.g. a single chain fatty acid) is dissolved in a solvent such as octadecene (ODE) or trioctylphosphine oxide (TOPO) in a three neck round flask. Flush with nitrogen arid heat to 300° C. until the solution is clear.

2. Preparing a solution of metal precursor with the desired concentration, in an oxygen free environment. The desired concentration is from about 0.1M to about 10M, and preferably about 1M. This concentration is established mainly for manufacturing and cost concerns, as higher concentrations produce more nanoclusters from a given volume of solvent. The amount of precursor solution prepared should be sufficient to allow for multi-aliquot additions should it be necessary to achieve desired nanocluster characteristics.

The desired amounts of ligand and metal precursor is selected based upon a number of factors, including batch size, but is selected in the molar ratio of ligand to metal precursor of about 10:1 to about 1:1. In some embodiments, the ratio is 5:1 to about 1:1, and in some embodiments, the ratio of ligand to metal precursor is 3:1.

3. Injecting the metal precursor solution into the ligand solution rapidly at 300° C. and then maintaining 270° C. while stirring until the reaction is complete (about 2-3 hours) in an oxygen free environment. An aliquot is taken at certain time intervals for reaction monitoring by a fluorometer.

4. Optionally injecting additional quantities of the metal precursor solution into the reaction mixture in one hour intervals. Between each injection, the nanoclusters are sampled and evaluated for the desired emission wavelength. The subsequent injections are to be expected, as the resultant wavelength is a function of nanocluster size, and additional size can be added through additional injections.

5. Finally, once a desired nano-crystal has been achieved, the reaction can bee cooled to room temperature. At this point, the nano-crystal can be separated and purified from the reaction mixture by known techniques. The purified nano-crystals can be used in further reactions, such as the capping reaction described below. Alternatively, the unpurified reaction mixture may also be used in further reactions.

The resultant nanocluster has a metal core surrounded by an outer layer of ligand.

### Method 2

A capping reaction may be used whereby the final nanocluster has a metal core, as described above, a capping layer, and an outer layer of ligand. The capping reaction begins with either purified nanocluster or the reaction product from the nanocluster synthesis reaction.

This method provides a nanocluster with improved stability. A few monolayers of another metal or semiconductor material (shell) with similar crystal lattice parameters but a higher band gap are grown on the surface of the cluster cores prepared in example 1 to minimize the electron wavelength function leakage from the cores. This isolates the cores from their surrounding environment and minimizes environmental degradation. In this example, Gallium is selected as the metal coating material.

Maintain an oxygen free environment during the capping process. Take a sample of Al clusters synthesized in example 1 and:

1) Add desired amount of solvent such as TOPO or ODE, and a ligand, vacuum purge 10 minutes, and then switch to nitrogen. The desired amount is again based upon batch size, provided the ratio of ligand to metal precursor is about 10:1 to about 1:1, about 5:1 to about 1:1, or about 3:1.

2) Heat to 200° C. for 30 minutes

3) Prepare a solution of trimethylgallium solution with desired volume and concentration in an oxygen free environment. As before the volume is dependent upon batch size, and the above ratios. The concentration is about 0.1M to about 10M, or about 1M

4) Drip the capping solution into (2)

5) Stir for 2 hours at 200° C. under nitrogen.

6) Allow to cool to room temperature

### Method 3

This example provides a method to coat the nanoclusters as prepared by a semiconductor material to improve their stability. Any suitable semi-conductor material may be used. For example, ZnS is selected as the coating layer because of the higher band gap and better stability. Capped nanoclusters are prepared as in method 2 employing semiconductor material and a suitable solvent.

### Method 4

This example is a preferred method that provides a nanocluster with improved stability by an alternate mechanism. The core nanocluster or core/shell nanoclusters are allowed to oxidize on their surfaces under controlled conditions to form a metal oxide coating. A metal oxide insulating layer is formed.

In method 1 and 2, once the emission wavelength reaches to the desired point, decrease the temperature to about 100° C., then blow air through the reaction flask for 2-3 hours, this will allow a metal oxide insulating layer to form to improve their stability.

### Method 5

This example is a preferred method that produces a population of nanoclusters with multiple discrete sizes. This produces multiple emission peaks in a single batch.

1) Prepare a desired amount of organic ligand such as a single chain fatty acid and solvent such as octadecene (ODE) or trioctylphosphine oxide (TOPO) in a three neck round flask. Flush with nitrogen and heat to 300° C. until the solution is clear.

2) In an oxygen free environment, prepare a solution of aluminum precursor (trimethylaluminum or aluminumnitride) with desired concentration.

3) Inject (2) into (1) slowly at 300° C. and then maintain 270° C. Stir until the reaction is complete (2-3 hours)—maintain an oxygen free environment. An aliquot is taken at certain time intervals for reaction monitoring by a fluorometer.

### Example 1

### Aluminum Nanocluster with Emission Wavelength of 540 nm

This example describes a method to synthesize fluorescent aluminum nanoclusters with an organic ligand.

1) the ligand solution was prepared by dissolving 2 g lauric acid (ligand) in 10 mL of octadecene (ODE) in the presence of 0.5 g Zinc acetate in a three neck round flask. The flask was degassed under vacuum for about 30 minutes and flushed with arid nitrogen while heated to 300° C. until the solution was clear.

2) In an oxygen free environment, an aluminum precursor solution was prepared by mixing 8 mL of ODE with 3 mL of trimethylaluminum (TMAl, 10% in hexane).

3) the entire quantity of aluminum precursor solution was injected rapidly into the ligand solution at 300° C. while maintaining 270° C. and stirred until the reaction was complete (3 hours) in an oxygen free environment. An aliquot was taken at certain time intervals for reaction monitoring by a fluorometer.

4. an aliquot of the precursor mixture (4 mL ODE, 1 mL trimethylaluminum) was injected into the reaction, and mixed for one hour. A sample was taken and evaluated.

5. an aliquot of the precursor mixture (3 mL ODE, 1 mL trimethylaluminum) was injected into the reaction, and mixed for one hour. A sample was taken and evaluated.

6. an aliquot of the precursor mixture (4 mL ODE, 1 mL trimethylaluminum) was injected into the reaction, and mixed for one hour. A sample was taken and evaluated. Samples of the aluminum nanoclusters obtained from this reaction produced an emission wavelength of approximately 540 nm.

A set of nanoclusters for each emission wavelength was prepared according to the method of Example 1. With the exception of the 420 nm nanocluster, all reaction conditions were substantially the same differing only by catalyst content. As shown in the table below, the addition of greater amount of catalyst results in longer wavelengths, which correspond to larger nanoclusters. Similar results could be obtained from altering other conditions, such as reaction time.

Chemical Ratio/Amount For Emission
Wavelength Control During Synthesis

| ODE | LA | Zn(Ac)₂ | TMAl | Wavelength |
|---|---|---|---|---|
| (ml) | (g) | (g) | (ml) | (nm) |
| 10 | 2 | 0.05 | 3 | 420 |
| 10 | 2 | 0.10 | 6 | 480 |
| 10 | 2 | 0.50 | 6 | 540 |
| 10 | 2 | 1.0 | 6 | 580 |
| 10 | 2 | 2.0 | 6 | 630 |
| 10 | 2 | 3 | 6 | 660 |

### Example 2

This method provides a nanocluster with improved stability. A few monolayers of gallium (shell) are grown on the surface of the cluster cores prepared in example 1 to minimize the electron wavelength function leakage from the cores. This isolates the cores from their surrounding environment and minimizes environmental degradation. An oxygen free environment was maintained during the capping process.
1) 0.6 g of purified Al clusters from Example 1 were placed in a three neck flask, 10 ml of ODE and 1 g of LA were added, vacuumed for 10 minutes, and then switched to nitrogen
2) the mixture was heated to 200° C. for 30 minutes
3) a capping solution was prepared by mixing 6 ml of ODE and 2 ml of trimethylgallium (10% in Hexane) in an oxygen free environment.
4) the capping solution was dripped into heated mixture within 5 minutes
5) and stirred for 2 hours at 200 C under nitrogen
6) The mixture was allowed to cool to room temperature.

The resultant nanocluster had an aluminum core surrounded by a gallium shell and an outer lauric acid ligand layer.

### Example 3

For capping Al clusters with a semiconductor material, ZnS.
1) 0.6 g of purified Al clusters from Example 1 was placed in a three neck flask, 10 ml of ODE and 1 g of LA was added, vacuumed for 10 minutes, and then switched to nitrogen
2) the mixture was heated to 200° C. for 30 minutes
3) a capping solution by mixing 6 ml of OED, 2 ml of dimethylzinc (10% in Hexane), and 300 ul of Hexamethyldisilathiane was prepared in an oxygen free environment.
4) the capping solution was dripped into the heated mixture within 5 minutes
5) and stirred for 2 hours at 200 C under nitrogen
6) the mixture was allowed to cool to room temperature.

The resultant nanocluster had an aluminum core surrounded by a ZnS semiconductor shell and an outer lauric acid ligand layer.

### Example 4

This example is a preferred method that provides a nanocluster with improved stability by an alternate mechanism. The core nanocluster or core/shell nanoclusters of Examples 2 and 3 are allowed to oxidize on their surfaces under controlled conditions to form a metal oxide coating. A metal oxide insulating layer is formed.

To achieve the metal oxide layer, in example 1 and 2, once the emission wavelength reaches to the desired point, decrease the temperature to about 100° C., then blow air through the reaction flask for 2-3 hours, this will allow a metal oxide insulating layer to form to improve their stability.

### Example 5

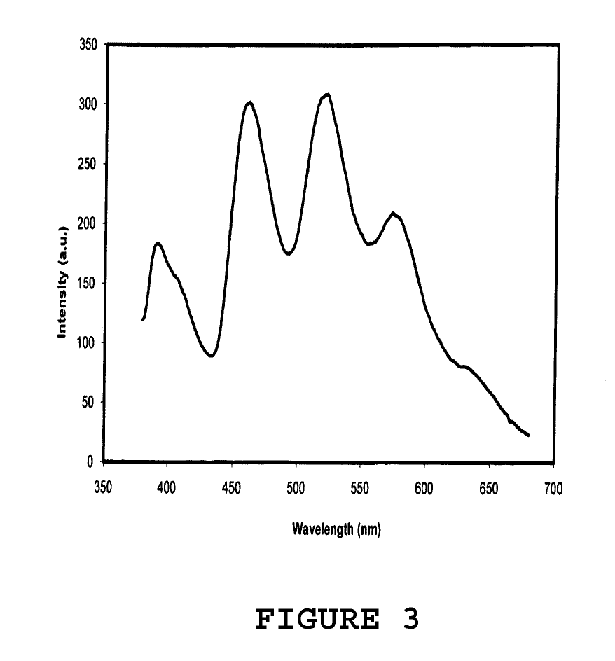

This example is a preferred method that produces a population of nanoclusters with multiple discrete sizes. This produces multiple emission peaks in a single batch (FIG. 3).
1) 2 g of lauric acid (LA, ligand), 10 ml of ODE (solvent), and 0.5 g of Zinc acetate (Zn(Ac)₂) (catalyst) were loaded into a three neck flask with a temperature meter and controller. The flask was sealed and vacuum used to degas for 30 minutes, and then switched to nitrogen. The temperature was raised to 300° C.
2) In an O₂ free environment, 8 ml of ODE and 3 ml of trimethylaluminum(TMAl) (10% in hexane) were mixed.
3) the trimethylaluminum solution was injection into the ligand solution slowly (within 2 minutes) at 300° C. and then maintained at 270° C. The reaction was stirred until the reaction is complete (2-3 hours).

The emission spectra of this cluster mixture are shown in FIG. 3.

### Applications

### High Efficient, Safe and Stable Biomarkers

In the life science area, high sensitive optical probe is a power tool to detect inner structure of cells, tissues and organs, as well as their changes, as a result, it provides a power tool for fundamental interest, as well as disease diagnostic and detection. The optical probes widely used at this moment are fluorescent proteins and organic dyes. However, these organic phosphors have very short lifetime, normally from few seconds to few minutes, this prevents them from being used for long term detection purpose, such as cell tracking. Moreover, the narrow absorption and wide emission profile make them very difficult for multiplexing events. Semiconductor quantum dots provide powerful alternative, however, the current commonly used quantum dot materials contain heavy metals such as Cadmium and Lead. The serious safety issue prevents them from being used for in vivo imaging and detection, in addition, their size is normally 5-8 nanometers in diameter which limits their penetration in cells and tissues, result in a low sensitivity and detection quality. The metal clusters developed at Crystalplex made of safe metal materials, for example, but not limited to Aluminum, Gallium and their alloys. These heavy metal free clusters can be safely used for developing high sensitive bio probes with the potential to replace the current fluorescent proteins and organic dyes, as well as Cd based semiconductor quantum dots, meanwhile maintain the unique properties of quantum dots, such as high quantum efficiency, high stability, wide absorption and narrow emission profiles, flexible emission wavelength and surface configuration. The method for making them biocompatible includes, but not limited to ligand exchange, polymer encapsulation

### Light-Emitting Diode (LED) Emitters.

An issue with current Gallium Nitride (GaN) based white LEDs is that the yellow, green and red down-converting phosphors are inefficient and are not precisely tunable in emission color. This is due to the inherent properties of the materials used to make them. Semiconductor quantum dots have a promising potential for LED phosphors, however, the materials used to make them, for example, CdSe, CdS, PbSe, PbS have toxicity and environmental issues.

The high quantum efficiency and stability, as well as the tunable emission wavelength from UV to red make the Al nanoclusters a better candidate for LED emitters. In addition, the flexible surface property simplifies device fabrication process.

The high fluorescent metal clusters can also be used as emissive layers in OLED devices through direct charge injection; These OLEDs can be used for display, LCD backlight and general lighting applications.

### Solar Cell Light Absorption and Energy Transfer Materials

Crystalline silicon thin-film solar cells are inefficient as capturing certain wavelengths of light which limits their efficiency. Metal nanoclusters can increase solar panel efficiency. Nanoclusters over a size range can be blended and coated on solar cells to optimize light absorption, especially on the longer (redder) and shorter (bluer) ends of the spectrum. The electrons in metal nanoclusters are highly sensitive to visible light and react by emitting their own photons in the form of “surface plasmons”—electromagnetic waves that propagate across the surface of the panel rather than through it. The plasmons come into contact with the cell's silicon atoms, increasing the conversion of light into electricity. The enhanced photon/metal cluster interaction results in an “antenna effect” allowing more of the electromagnetic radiation from sunlight to be converted into electricity. The metal nanoclusters can enhance the efficiency of Si-based solar panels as well as organic solar panels.

### Security Inks and Coatings

Metal nanoclusters can be formulated in inks and paints for security and anti-counterfeiting applications. Multiple nanoclusters can be combined to create unique fluorescent spectral barcodes that identify any object or document upon illumination. By altering the surface ligand, nanoclusters can be made compatible with conventional screen, flexographic, offset, gravure, and ink jet printing inks as well as coating formulations and paints.

### Molecular Level Detection Tools

Metal clusters have tremendously enhanced Raman scattering intensities with three to five orders of magnitude enhancement compare to bulk materials. This enables the development of Raman scattering related molecular level detection tools for photothermal detection, single-molecule observation, early stage observation on surfaces and colloids by using cluaters. This selectivity is not only important in identifying particular molecular vibrations, but also important for locating electronic transitions within the molecule's absorption spectrum, even when the direct electronic spectra are totally vibrationally unresolved.

### Catalysis Reagent

They can also be used as catalysis reagents in chemical and biological reactions. Moreover, their fluorescent character allows them to be used as both catalysis and monitor reagent to monitor reaction dynamics.

The above descriptions and examples are meant to be illustrative. Those of skill in the art will readily appreciate variants which fall within the scope and spirit of the claims.

What is claimed is:

1. A nanocluster comprising:
a photoluminescent metal core wherein said metal is selected from the elements found in groups IB, IIB, IIA, IVA, VA, and VIA of the periodic table; and
a layer of organic ligands disposed outside of said core.

2. The nanocluster of claim 1, wherein said metal is selected from the elements found in groups IB, IIB, or IIIA of the periodic table of elements.

3. The nanocluster of claim 1, wherein said metal is selected from the elements found in group IIA of the period table of elements.

4. The nanocluster of claim 1, wherein said metal is selected from Al, Ga, mixtures and alloys thereof.

5. The nanocluster of claim 1, wherein said non-noble metal is Al or alloys thereof.

6. The nanocluster of claim 1, wherein said non-noble metal is Ga or alloys thereof.

7. The nanocluster of claim 1 wherein said organic ligands are single chain fatty acids, which may be substituted or unsaturated.

8. The nanocluster of claim 1, wherein said organic ligands are single chain fatty acids having 8 to 18 carbons, which may be saturated or unsaturated

9. The nanocluster of claim 1, wherein said nanocluster comprises from about 3 to about 300 atoms.

10. The nanocluster of claim 1, wherein said nanocluster comprises from about 3 to about 100 atoms

11. The nanocluster of claim 1, wherein the band gap of said nanocluster is tunable from about 0.2 Ev to 4 Ev.

12. The nanocluster of claim 1, wherein said emission wavelength can be selectively tuned from about 400 nm to about 650 nm.

13. The nanocluster of claim 1, wherein said nanocluster is about 3-10 nm in diameter.

14. A nanocluster comprising:
a photoluminescent metal core wherein said metal is selected from the elements found in groups IB, IIB, IIIA, IVA, VA, and VIA of the periodic table;
a shell layer wherein said shell layer is selected from a metal, metal oxide, or semi-conductor material; and
a layer of organic ligands disposed outside of said shell layer.

15. The nanocluster of claim 14, wherein said shell layer is a metal selected from the elements found in groups IB, IIB, IIIA, IVA, VA, and VIA of the periodic table.

16. The nanocluster of claim 14, wherein said shell layer is a metal selected from the elements found in group IIIA of the periodic table

17. The nanocluster of claim 14 where the semiconductor material is ZnS.

18. A method of making a nanocluster comprising:
adding a solution of metal precursor to a solution of a ligand dissolved in the absence of oxygen and under at about 300° C. and maintaining a reaction temperature of about 270° C. until the reaction is complete;
adding an aliquot of metal precursor solution to the reaction mixture and stirring;
repeating the addition step until the desired properties are attained.

19. The method of claim 18, wherein said metal precursor solution is an organometallic complex, a metal salt, or a metal oxide of a metal is selected from the elements found in groups IB, IIB, IIA, IVA, VA, and VIA of the periodic table in a solvent.

20. The method of claim 18, wherein said ligand is single chain fatty acid, which may be saturated or unsaturated.

21. The method of claim 18, further providing the step of forming a shell layer between said core and said ligand layer, comprising:
dripping a capping solution comprising a precursor solution of a metal, metal oxide, or a semiconductor material into a solution containing a nanocluster sample to a ligand solution to yield nanoclusters having a metal core, a shell comprising said metal, metal oxide or semi-conductor material, and an outer ligand layer.
